(19) United States
(12) Patent Application Publication
(10) Pub. No.: US 2024/0079901 A1
(43) Pub. Date: Mar. 7, 2024

(54) POWER TOOL WITH HYBRID SUPERCAPACITORS

(71) Applicant: Emerson Professional Tools, LLC, Elyria, OH (US)

(72) Inventors: Harald KRONDORFER, Aurora, OH (US); Naga PENMETSA, Avon, OH (US)

(73) Assignee: Emerson Professional Tools, LLC, Elyria, OH (US)

(21) Appl. No.: 18/267,372

(22) PCT Filed: Dec. 13, 2021
(86) PCT No.: PCT/US2021/072884

§ 371 Date: Jun. 14, 2023

(30) Foreign Application Priority Data
Dec. 15, 2020 (IN) 202021054577

(51) Int. Cl. H02J 7/34; B25F 5/00; H01G 11/10; H01G 11/36; H02K 7/14

(52) U.S. Cl. CPC H02J 7/345; B25F 5/00; H01G 11/10; H01G 11/36; H02K 7/145

(57) ABSTRACT

A power tool includes: an electric motor; an energy storage device (a) that includes hybrid supercapacitors and (b) that has an energy density of at least approximately 150 watt hours per kilogram (Wh/kg); and at least one switch configured to selectively enable power flow from the energy storage device to the electric motor and to selectively disable power flow from the energy storage device to the electric motor.

### CROSS-REFERENCE TO RELATED APPLICATIONS

This application claims the benefit of Indian Application No. 202021054577, filed on Dec. 15, 2020. The entire disclosure of the application referenced above is incorporated herein by reference.

### FIELD

The present disclosure relates to electric power tools and more particularly to electric power tools powered by energy storage devices including hybrid supercapacitors.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Cordless power tools offer advantages over corded power tools, such as use without access to an outlet, freedom from a cord, etc. Various type of power tools may be powered using a lithium ion (Li-ion) battery. Some high power demand power tools, however, may be corded, such as outdoor power tools, drain cleaners, concrete saws, threading machines, power drives, etc. Li-ion batteries may or may not be used with such high power demand power tools.

Electric motors such as electronically commutated motors like brushless DC motors may be capable of delivering high power output for an extended period of time, resulting in high current draw from a battery. While some Li-ion batteries may be capable of handling high discharge currents (e.g., more than 20 Amps), the currents drawn by high power demand power tools may exceed the capabilities of Li-ion batteries.

### SUMMARY

In a feature, a power tool includes: an electric motor; an energy storage device (a) that includes hybrid supercapacitors and (b) that has an energy density of at least approximately 150 watt hours per kilogram (Wh/kg); and at least one switch configured to selectively enable power flow from the energy storage device to the electric motor and to selectively disable power flow from the energy storage device to the electric motor.

In further features, the hybrid supercapacitors are electrically connected in series.

In further features, the hybrid supercapacitors are electrically connected in parallel.

In further features, the hybrid supercapacitors include (a) hybrid supercapacitors that are electrically connected in series and (b) hybrid supercapacitors that are electrically connected in parallel.

In further features, a control module is configured to open and close the at least one switch, thereby controlling power flow from the energy storage device to the electric motor.

In further features, an input device is included, and the control module is configured to control switching of the switches based on input from the input device.

In further features, the energy storage device is integrated into the power tool and not removable from the power tool.

In further features, the energy storage device is removable from the power tool.

In further features, the hybrid supercapacitors store power electrostatically.

In further features, electrodes of the hybrid supercapacitors include graphene.

In further features, electrodes of the hybrid supercapacitors include a nanocarbon material.

In further features, the energy storage device has a nominal output voltage of at least 24 volts direct current (DC).

In further features, the energy storage device has a power density of at least approximately 1000 W/kg.

In further features, the hybrid supercapacitors are each cylindrical.

In further features, the hybrid supercapacitors each include two terminals extending outwardly from a circular face of the cylindrical hybrid supercapacitors.

In further features, a circuit board is included, and the hybrid supercapacitors are soldered on the circuit board.

In a feature, a power tool includes: an electric motor; an energy storage device that includes hybrid supercapacitors, wherein each of the hybrid super capacitors includes: a first electrode that includes a nanocarbon material; and a second electrode that includes lithium; and at least one switch configured to selectively enable power flow from the energy storage device to the electric motor and to selectively disable power flow from the energy storage device to the electric motor.

In further features, the hybrid supercapacitors are electrically connected in series.

In further features, the hybrid supercapacitors are electrically connected in parallel.

In further features, the hybrid supercapacitors include (a) hybrid supercapacitors that are electrically connected in series and (b) hybrid supercapacitors that are electrically connected in parallel.

In further features, a control module is configured to open and close the at least one switch, thereby controlling power flow from the energy storage device to the electric motor.

In further features, an input device is included, and the control module is configured to control switching of the switches based on input from the input device.

In further features, the energy storage device is integrated into the power tool and not removable from the power tool.

In further features, the energy storage device is removable from the power tool.

In further features, the hybrid supercapacitors store power electrostatically.

In further features, nanocarbon material includes graphene.

In further features, the energy storage device has a nominal output voltage of at least 24 volts direct current (DC).

In further features, the energy storage device has an energy density of at least 150 watt hours (Wh) per kilogram (kg) and a power density of at least approximately 1000 watts per kg.

In further features, the hybrid supercapacitors are each cylindrical.

In further features, the hybrid supercapacitors each include two terminals extending outwardly from a circular face of the cylindrical hybrid supercapacitors.

In further features, a circuit board is provided, and the hybrid supercapacitors are electrically connected via the circuit board and soldering.

In a feature, a charger includes: a plug configured to electrically connect to an alternating current (AC) wall outlet; a cable electrically connected at one end to the plug; a converter module configured to receive AC power via the plug and the cable and that is configured to convert the AC power into direct current (DC) power; and a charging module configured to, using DC power originating from the converter module, charge a first plurality of hybrid supercapacitors that power an electric power tool.

In further features, a control module is configured to disable the charging module and discontinue the charging when at least one of an over-voltage condition occurs, an over-current condition occurs, and an over-temperature condition occurs.

In further features, the charger includes an energy storage device (a) that is internal to the charger and (b) that includes a second plurality of hybrid supercapacitors.

In further features, the first plurality of hybrid supercapacitors have a first capacity, the second plurality of hybrid supercapacitors have a second capacity, and the second capacity is greater than the first capacity.

In further features, the first plurality of hybrid supercapacitors have a first nominal voltage, the second plurality of hybrid supercapacitors have a second nominal voltage, and the second nominal voltage is greater than the first nominal voltage.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A-1B are functional block diagrams of an example implementation of a power tool;

FIGS. 2-4 include functional block diagrams of example arrangements of hybrid supercapacitors;

FIG. 5 is a perspective view of an example implementation of hybrid supercapacitors;

FIGS. 6A, 6B, 6C, and 7 are functional block diagrams of an example implementation of a charger;

FIGS. 8A-8B are functional block diagrams of an example implementation of the power tool of FIG. 1; and

FIG. 9 includes a functional block diagram of an example implementations of a power tool and a charger.

In the drawings, reference numbers may be reused to identify similar and/or identical elements.

### DETAILED DESCRIPTION

Lithium-ion (Li-ion) batteries may have characteristics that prevent or severely limit their usefulness for applications that require a high power output. For example, Li-ion batteries store energy electrochemically, which means that chemical reactions take place during charging and discharging. As a result, Li-ion batteries have a noticeable internal resistance, which may limit the Li-ion battery's current capabilities during charging and discharging. Also, because energy is stored and transferred electrochemically, Li-ion batteries are subject to aging. The life of a Li-ion battery may be 500 to 800 charge/discharge cycles before the capacity of the Li-ion battery decreases.

Li-ion batteries may require strict control of current, voltage, and temperature during charging and discharging. If for example subjected to discharge currents that are too high or if discharged to voltages below certain limits, Li-ion batteries can be irreversibly damaged.

Li-ion batteries may also have limited charge currents. In other words, Li-ion batteries may be limited to charging at up to a predetermined charging rate. The predetermined charging rate may be slower than a predetermined maximum discharge rate. Therefore, it may take longer to fully charge a Li-ion battery than the period to discharge the Li-ion battery.

One or more materials (e.g., the electrolyte) used in Li-ion batteries may be flammable. Li-Ion batteries including two or more Li-Ion battery cells are charged using an electronic battery management systems (BMS) to ensure proper charging and discharging. The BMS may be part of the battery, part of the tool, or part of the charger and increases cost.

Li-ion batteries greater than some capacities (e.g., 100 watt hours (Wh)) may not be transported by air via air carriers. It may be desirable to be able to airship power tools (and/or batteries) with capacities greater than those allowed by one or more regulation and/or air carriers for Li-ion batteries. The above may be true for other types of batteries.

The present application involves energy storage devices for power tools using hybrid supercapacitors (also referred to as hybrid ultracapacitors). Hybrid supercapacitors store energy electrostatically. This is in contrast with batteries, which store energy electrochemically. Hybrid supercapacitors have low internal resistance and can be charged and discharged at higher rates than Li-ion batteries. Hybrid supercapacitors have a higher energy density than standard capacitors and other types of capacitors.

Hybrid supercapacitors include specialized forms of carbon (e.g., activated carbon, graphite, graphene, etc.) and have higher energy densities than (non-hybrid) supercapacitors and ultracapacitors. Hybrid supercapacitors utilize the advantages of graphene and/or nanocarbons to provide high energy density and high current capabilities (charging and discharging). Energy storage devices including hybrid supercapacitors may have energy densities that are near or greater than the energy density of a comparable Li-ion battery. For example, hybrid supercapacitors may have an energy density of approximately 150 Watt hours per kilogram (Wh/kg) or greater. Hybrid supercapacitors may have a power density of at least approximately 1000 W/kg or greater. With these energy and power densities, a power tool may be able to operate longer, charge and discharge faster, and achieve one or more other benefits over Li-ion batteries.

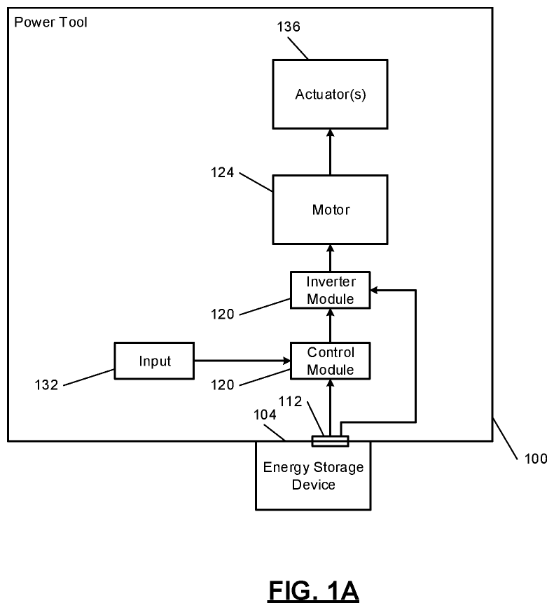

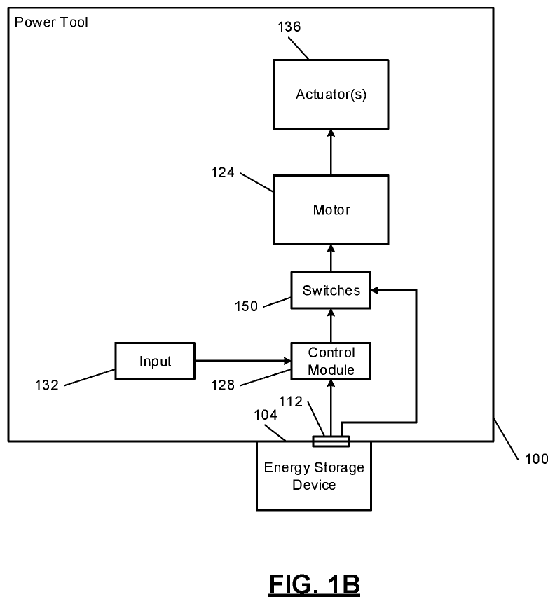

FIGS. 1A and 1B are functional block diagrams of an example implementation of a (cordless electric) power tool 100. The power tool 100 may be a metal saw, a pipe threader, a backpack vacuum, a chainsaw, a concrete saw, a drain cleaner, or another suitable type of power tool. The power tool 100 may not include or receive power from any lithium ion batteries.

The power tool 100 is powered using an energy storage device 104. The energy storage device 104 includes a plurality of hybrid supercapacitors (e.g., cells), as discussed further below. The power tool 100 and/or the energy storage device 104 may include one or more interfaces 112, such as electrical interfaces and mechanical interfaces. Electrical interfaces provide electrical communication. Mechanical interfaces may be configured to secure the energy storage device 104 to the power tool 100 and to align electrical interfaces of the power tool 100 with electrical interfaces of the energy storage device 104. The energy storage device 104 may be removable from the power tool 100, such as in the examples of FIGS. 1A and 1B.

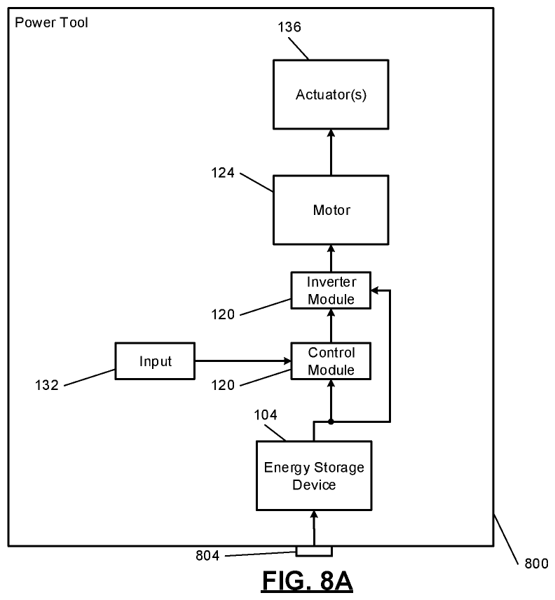

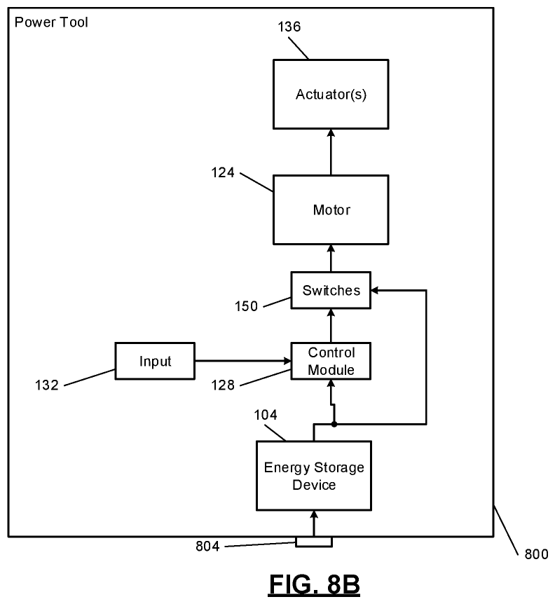

In various implementations, the battery 104 may be integrated into the power tool 100 and not removable from the power tool 100 (e.g., see FIGS. 8A and 8B).

The energy storage 104 has at least a predetermined capacity and a predetermined nominal output voltage. For example only, the predetermined nominal output voltage may be 24 Volts (V) direct current (DC) or greater. The predetermined capacity may be, for example, 2 Amp hours (Ah) or greater. The energy storage device 104 may have an energy density of at least approximately 150 Wh/kg or another suitable energy density. The energy storage device may have a power density of at least approximately 1000 W/kg.

In the example of FIG. 1A, the power tool 100 includes an inverter module 120. The inverter module 120 may include a three phase DC to alternating current (AC) inverter and invert a DC voltage from the energy storage device 104 into three phase AC. The inverter module 120 outputs AC power to an electric motor 124 in the example of FIG. 1A. In the example of FIG. 1A, the electric motor 124 may be a brushless DC (BLDC) motor, a permanent magnet synchronous motor (PMSM), or another suitable type of motor.

In the example of FIG. 1A, the inverter module 120 includes a plurality of switches that are switched to apply power from the energy storage device 104 to the motor 124. The switches may be, for example, field effect transistors (FETs) or another suitable type of switch. A control module 120 controls switching of the switches of the inverter module 120.

The control module 128 may control the switching of the switches based on input from one or more input devices, such as input device 132. One example of an input device is an on/off switch, such as in the example of a fixed speed motor. The control module 128 may switch the switches at a predetermined (fixed) rate in the example of a fixed speed motor. Another example of an input device includes a trigger, a lever, a foot switch or another suitable type of device that provides a variable input corresponding to a (variable) target speed in the example of a variable speed motor. In the example of a variable speed motor, the control module 128 may adjust the switching rate of the switches based on the input from the input device 132. In various implementations, the power tool may include both an on/off switch and a variable input device.

In the example of FIG. 1B, the electric motor 124 may include a permanent magnet DC (PMDC) motor or another suitable type of motor. The power tool 100 includes switches 150 that control the application of power from the energy storage device 104 to the motor 124. The control module 120 may control switching of the switches based on input from the input device(s) 132.

The control module 128 may switch the switches 150 at a predetermined (fixed) rate in the example of a fixed speed motor. In the example of a variable speed motor, the control module 128 may adjust the switching rate of the switches 150 based on the input from the input device 132. In various implementations, the power tool 100 may include both an on/off switch and a variable input device.

Referring now to FIGS. 1A and 1B, rotation of an output shaft of the motor 124 actuates an actuator 136. One or more other mechanisms may translate rotation of the output shaft to actuation of the actuator 136. The actuator 136 may depend on the type of the power tool 100. For example, a saw may include a saw blade, and the motor 124 may drive rotation of the saw blade. In the example of a backpack vacuum, the motor 124 may drive rotation of a vacuum element or fan. In the example of a drill, the motor 124 may drive rotation of a chuck. The motor 124 may actuate the actuator 136 linearly, rotationally, or both. While the example of one actuator and one motor is provided, the power tool 100 may include multiple motors and multiple actuators. In the example of multiple motors and multiple actuators, multiple converter modules may be provided, such as one converter module per motor and actuator.

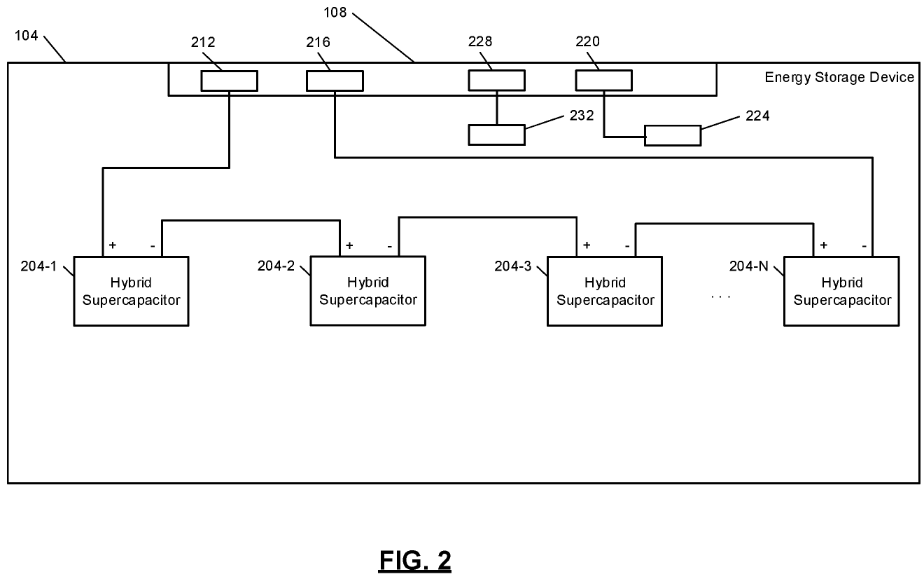

FIGS. 2-4 are functional block diagrams of example implementations of the energy storage device 104. The energy storage device 104 includes multiple individual hybrid supercapacitor cells, such as hybrid supercapacitors 204-1, 204-2, 204-3, . . . , 204-N(collectively “hybrid supercapacitors 204”). While the example of four hybrid supercapacitors is provided, the energy storage device 104 may have a greater or lesser number of hybrid supercapacitors. N is an integer greater than or equal to 1. In various implementations, the energy storage device 104 may include more than 50 hybrid supercapacitors, more than 100 hybrid supercapacitors, etc.

Each of the hybrid supercapacitors 204 is carbon based and includes carbon, such as in its electrodes. Each of the hybrid supercapacitors 204 may include at least one of graphene and one or more nanocarbon materials. The hybrid supercapacitors 204 may store power electrostatically. The hybrid supercapacitors 204 may not include a liquid electrolyte. The hybrid supercapacitors 204 all have equal voltage and energy capacity. The hybrid supercapacitors 204 may be identical.

The hybrid supercapacitors 204 may be electrically connected within a housing 208 of the energy storage device 104. As discussed further below, however, the housing 208 may be omitted, and the hybrid supercapacitors 204 may be integrated within the power tool 100.

The hybrid supercapacitors 204 may be connected in series. FIG. 2 includes an example of the hybrid supercapacitors 204 being connected in series. Series connection of the hybrid supercapacitors 204 may increase an output voltage of the energy storage device 104.

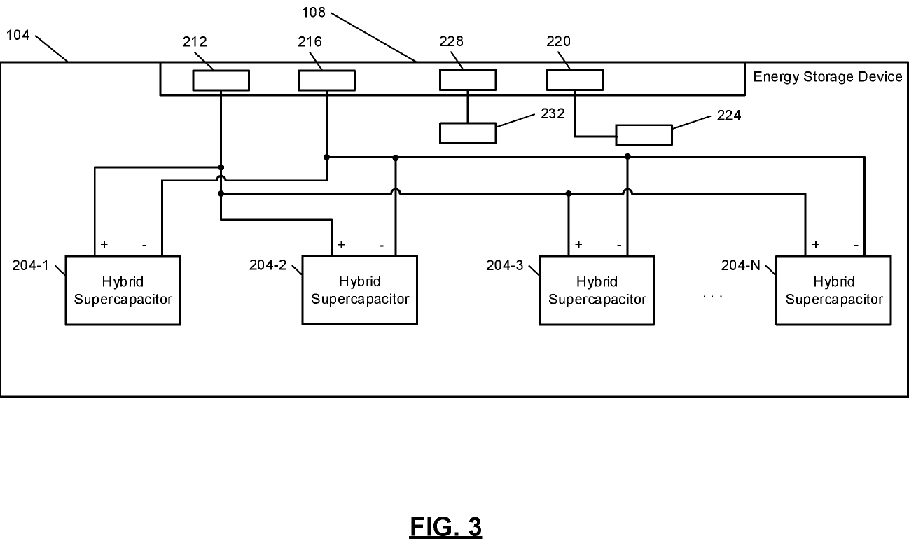

In various implementations, the hybrid supercapacitors 204 may be connected in parallel. FIG. 3 includes an example of the hybrid supercapacitors 204 being connected in parallel. Parallel connection of the hybrid supercapacitors 204 may increase a rating (e.g., Ah rating) of the energy storage device 104 without changing the output voltage.

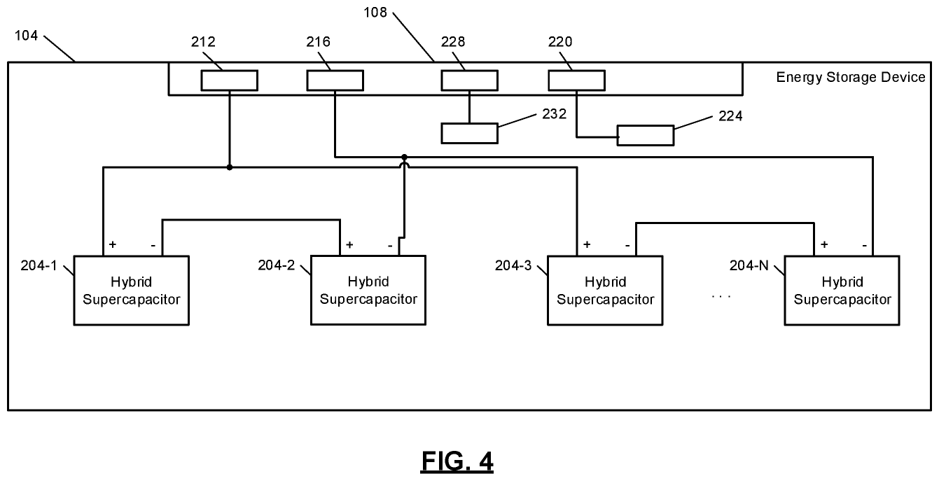

In various implementations, the energy storage device 104 may include both series and parallel connected hybrid supercapacitors. FIG. 4 includes an example of the hybrid supercapacitors 204 being connected in both series and parallel.

As shown in FIGS. 2-4, the hybrid supercapacitors 204 are connected to positive and negative electrical connectors 212 and 216. The energy storage device 104 may also include more other electrical connectors. For example, the energy storage device 104 may include a connector 220 used to electrically communicate a temperature of the energy storage device 104 measured using a temperature sensor 224. The energy storage device 104 may also include a connector 228 used to electrically communicate an identifier of the energy storage device 104. The identifier may be provided by an identification device 232, such as one or more resistors.

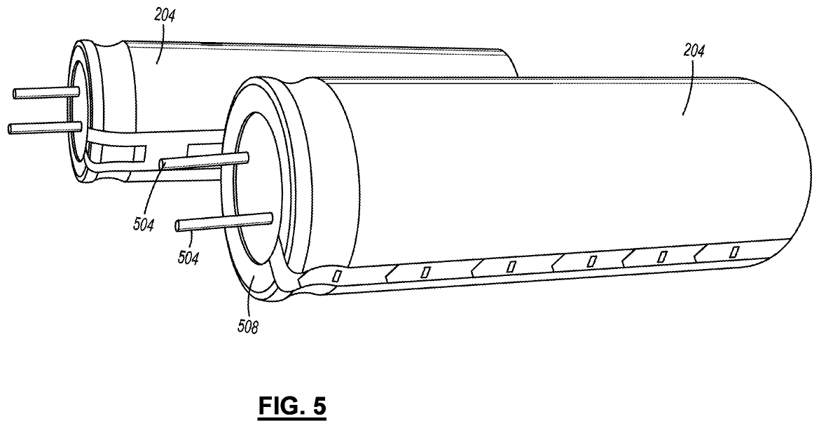

FIG. 5 includes a perspective view of two example hybrid supercapacitors. The hybrid supercapacitors 204 may be cylindrical, such as shown in the example of FIG. 5. Cylindrical as used herein may allow for one or more indented circular sections, such as illustrated in the example of FIG. 5. The hybrid supercapacitors 204, however, may have another suitable shape. Anode and cathode terminals 504 of each hybrid supercapacitor may extend outwardly from a circular face 508 of that individual hybrid supercapacitor cell.

The energy storage device 104 may also be referred to as a power pack. The power tool 100 may be a power tool with high current demand (e.g., at least approximately 30 Amps). Approximately as used herein may mean +/−10%. As discussed above, the power tool 100 receives electrical power from the energy storage device 104. The energy storage device 104 includes a bank of hybrid supercapacitors connected in series, parallel, or a combination of series and parallel. The energy storage device 104 has a nominal DC output voltage and a capacity. Examples of nominal DC output voltages include, but are not limited to, 10.8V (12V), 18V (20V), 36V (40V), 54V (60V), 72V (80V), 108V (120V) and may be configured to allow for compatibility with existing and future power tools. Peak voltages are provided above in parentheses. While example output voltages are provided, the present application is also applicable to other output voltages.

The hybrid supercapacitors may be cylindrical and may have positive and negative terminals that extend from the same circular face of the cylinder, such as shown in FIG. 5. The terminals of each of the hybrid supercapacitors may be welded or crimped to wires or to a printed circuit board assembly (PCBA) to electrically connect the hybrid supercapacitors. While the example of cylindrical shaped hybrid supercapacitors is provided, the present application is also applicable to other shapes and form factors, such as pouches and prismatic hybrid supercapacitors.

The PCBA may include one or more protection devices, such as one or more fuses and/or one or more balancing circuits. The balancing circuit(s) may include a Zener diode across each hybrid supercapacitor. In this example, the Zener diodes may also act as an over-voltage protection device for the hybrid supercapacitors.

The hybrid supercapacitors store energy electrostatically. The terminals of the hybrid supercapacitors are electrically conductive and electrically connected to the electrodes. In various implementations, the hybrid supercapacitors may include a carbon containing electrode (e.g., activated carbon, nanocarbon) and a metal oxide electrode. While the example of a carbon electrode and a metal oxide electrode are provided, electrodes of other materials may be used. Hybrid supercapacitors also include lithium. For example, the hybrid supercapacitors may include a carbon containing electrode and a lithium containing electrode.

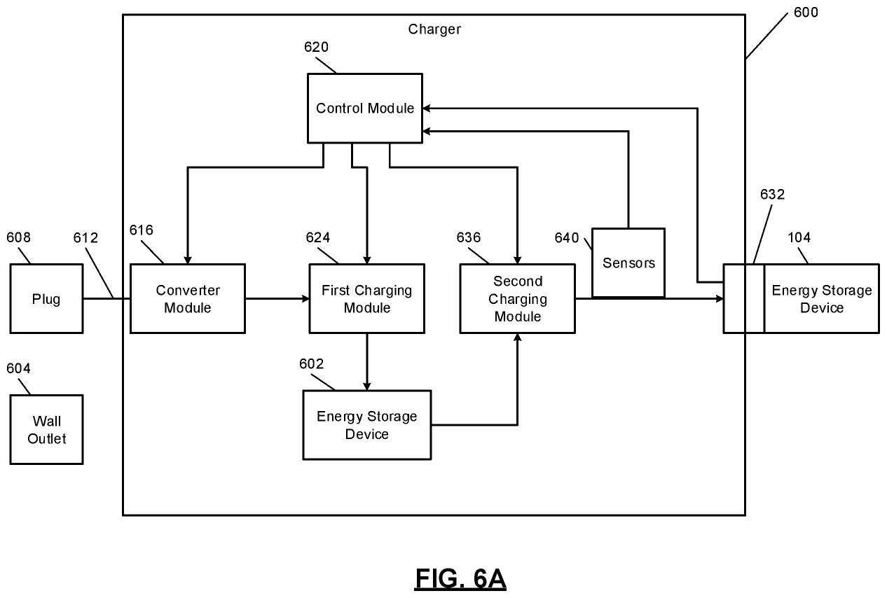

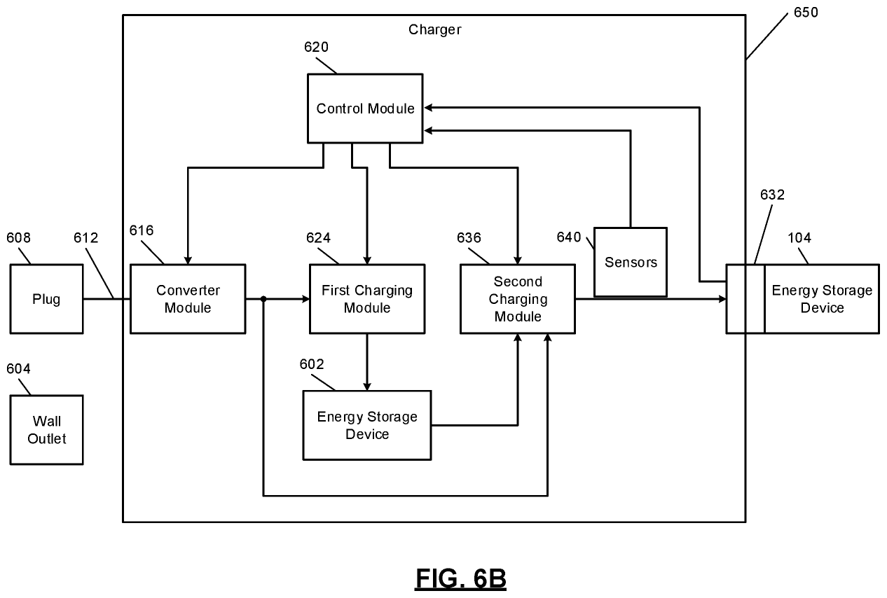

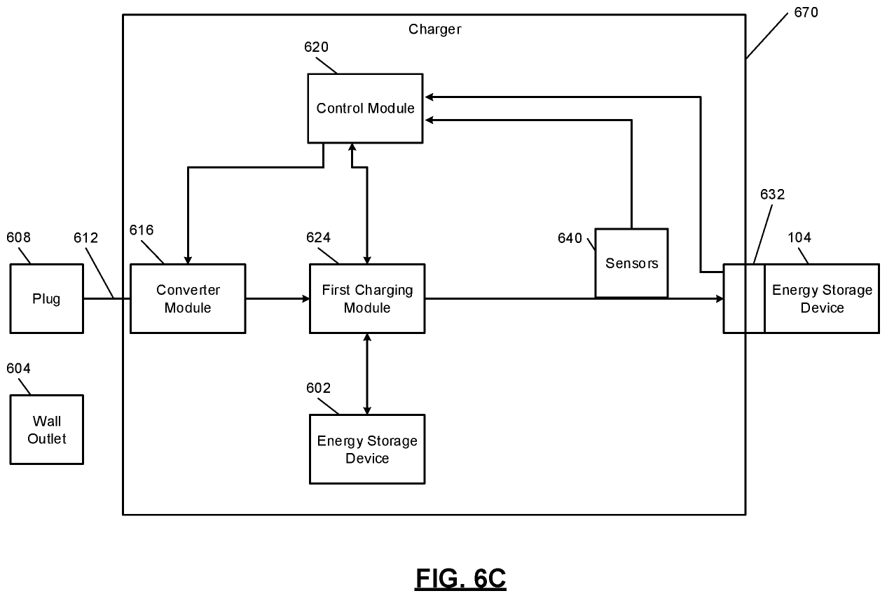

FIG. 6A is a functional block diagram of an example implementation of a charger 600 having an internal energy storage device 602. The charger 600 receives AC power from standard wall outlets, such as wall outlet 604. The charger 600 connects to wall outlets via a plug 608 that is electrically connected to a power cord 612.

A converter module 616 converts power received into power suitable for storage. The converter module 616 may include, for example, an AC to DC converter. The converter module 616 may also increase (boost) or decrease (buck) the voltage received.

The converter module 616 includes a plurality of switches that are switched to convert AC power into DC power. The switches may be, for example, FETs (field effect transistors) or another suitable type of switch. A control module 620 controls switching of the switches of the converter module 616.

The control module 620 may disable switching of the switches, for example, when an over-current, over-voltage, or over-temperature condition occurs. An over-current condition may occur, for example, when a current output from the charger 600 is greater than a predetermined current. Sensors 640 may include a current sensor that measures the current output from the charger 600. An over-voltage condition may occur, for example, when a voltage output of the charger 600 is greater than a predetermined voltage. The sensors 640 may include a voltage sensor that measures the voltage output of the charger 600. An over-temperature condition may occur, for example, when a temperature of the energy storage device 104 is greater than a predetermined temperature. The control module 620 may receive the temperature of the energy storage device 104 via the connector 220 of the energy storage device 104.

A first charging module 624 charges the energy storage device 602 with power output from the converter module 616. The first charging module 624 may include one or more switches that control power flow to the energy storage device 602 from the converter module 616. When open, the switch(es) prevent charging of the energy storage device 602. When closed, the switch(es) conduct power from the converter module 616 to the energy storage device 602 to charge the energy storage device 602 using power output from the converter module 616. The control module 620 may control switching of the switch(es) of the first charging module 624.

The energy storage device 602 includes a plurality of the hybrid supercapacitors 204. A nominal voltage of the energy storage device 602 may be greater than or equal to the nominal voltage of the energy storage device 104. This enables charging of the energy storage device 104 from the energy storage device 602. The energy storage device 602 may have a capacity that is greater than or equal to a capacity of the energy storage device 104.

The energy storage device 602 may include hybrid supercapacitors that are electrically connected in series, parallel, or a combination of series and parallel. If the energy storage device 602 is charged in advance, the charger 600 can be used to charge the energy storage device 104 even at times when the charger 600 is not plugged into and receiving power via a wall outlet.

The charger 600 and/or the energy storage device 104 may include one or more interfaces 632, such as electrical interfaces and mechanical interfaces. Electrical interfaces provide electrical communication. Mechanical interfaces may be configured to secure the energy storage device 104 to the charger 600 and to align electrical interfaces of the energy storage device with electrical interfaces of the charger 600. The energy storage device 104 is removable from the charger 600, such as for use with the power tool 100.

In the example of FIG. 6A, a second charging module 636 charges the energy storage device 104 using power output from the energy storage device 602. The second charging module 636 may include one or more switches that control power flow from the energy storage device 602 to the energy storage device 104. When open, the switch(es) prevent charging of the energy storage device 104. When closed, the switch(es) conduct power from the energy storage device 602 to the energy storage device 104 to charge the energy storage device 104. The control module 620 may control switching of the switch(es) of the second charging module 636.

The inclusion of the energy storage device 602 allows for fast charging of a connected energy storage device and, additionally, the ability to charge a connected energy storage device without the charger receiving power via a wall outlet.

FIG. 6B is a functional block diagram of another example implementation of a charger 650. In the example of FIG. 6B, the second charging module 636 can charge the energy storage device 104 using power from the energy storage device 602 or using power from the converter module 616.

FIG. 6C is a functional block diagram of another example implementation of a charger 670. In the example of FIG. 6C, the second charging module 636 is omitted. The first charging module 624 can charge the energy storage device 104 using power from the energy storage device 602 or using power from the converter module 616.

The energy storage device 104 can be charged quickly via a charger. The charge current for charging of the energy storage device 104 from the energy storage device 602 may be greater than the current that chargers can typically supply (e.g., via the output of the converter module 616). The charge time of such an ultrafast charger can be one tenth or less of the charge time of a charger that does not include the energy storage device 602. The charge time and the charge current of the charger 600 may only be limited by the internal resistance of the energy storage device 602 and by the resistance of the electrical conductors between the energy storage device 104 and the energy storage device 602. Also, because of the fast charge times (e.g., less than 10 minutes to full charge) provided by the chargers described above, the chargers described above can have a relatively small form factor relative to other types of power tool chargers because the heat dissipation from the charging occurs for only a relatively short period.

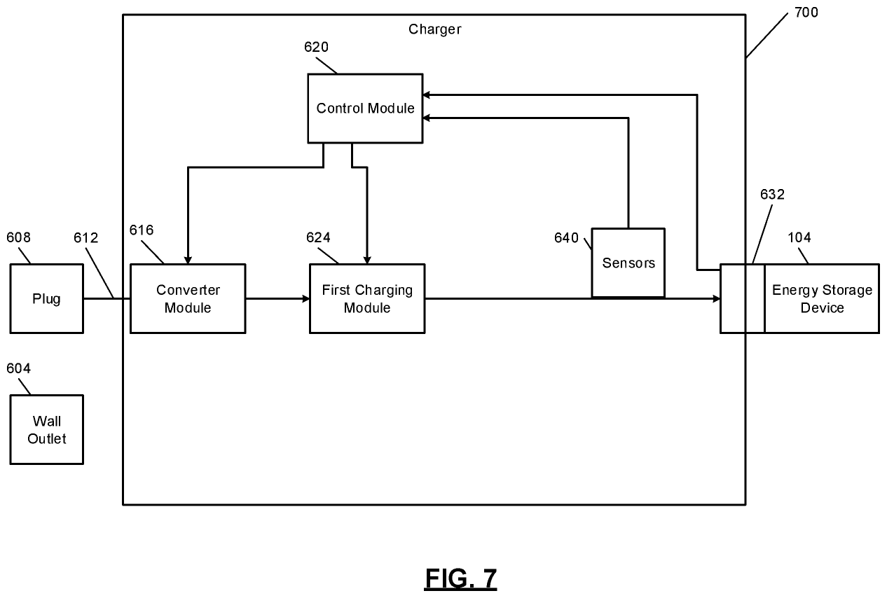

FIG. 7 is a functional block diagram of an example of charger 700 without the internal energy storage device 602. As shown in FIG. 7, the second charging module 640 and the energy device 602 may be omitted. In this example, the first charging module 624 may be used to charge the energy storage device 104 using power output from the converter module 616. Omitting the energy storage device 602 may further reduce a form factor of the charger 700.

In various implementations, the converter module 616 (e.g., the switches) may include wide bandgap technology switches (e.g., including gallium nitride (GaN) and/or silicon carbide (SiC)) to convert AC to DC. Also, the charge time of the energy storage device 602 is short relative to Li-ion chargers due to the use of hybrid supercapacitors in the energy storage device 602. The use of GaN and/or SiC wide bandgap switches may reduce an overall size (e.g., volume) of the charger 600.

One benefit of the energy storage device 104 being removable from the power tool 100 is that a user can continue to use the power tool 100 with a second energy storage device while the energy storage device 104 is charging. With the option to charge the energy storage device 104 faster via the chargers discussed above, the advantage of a second energy storage device (e.g., Li-ion battery) is minimized. The energy storage device 104 (including the hybrid supercapacitors 204) may therefore be integrated with the power tool 100 and may or may not be removable from the power tool 100. In various implementations, the energy storage device 104 may be replaceable, for example, for repair.

The power tool 100 (including the energy storage device 104) can then be charged using the chargers discussed above. With the fast charging times provided by the chargers of FIGS. 6A-6C, changing energy storage devices may be unnecessary. This implementation would also reduce cost as a set of contacts and separate housing components could be saved in addition to only providing a single energy storage device (including the hybrid supercapacitors) instead of two energy storage devices.

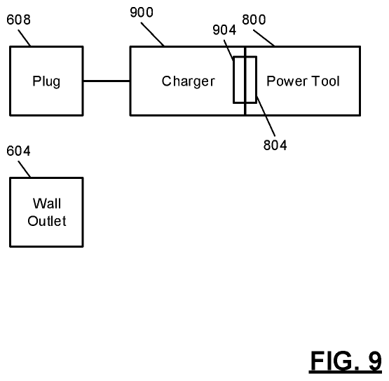

FIGS. 8A and 8B are functional block diagrams of an example implementation of a power tool 800 where the energy storage device 104 is integral to the power tool 800. In this example, the power tool 800 may include electrical interfaces (e.g., connectors) 804 that are located on a housing of the power tool 800 and can be electrically connected to via a charger, such as the chargers discussed above. Wiring may connect the electrical connectors 804 to the energy storage device 104. FIG. 9 is a functional block diagram 900 including electrical interfaces (e.g., connectors) 904 that electrically connect to the electrical interfaces (e.g., connectors) 804 of the power tool 100 having the integral energy storage device 104. The charger 900 may be one of the chargers discussed above with respect to FIGS. 6A-6C or FIG. 7.

In high demand power tools (e.g., threaders, steel saws, etc.) peak performance is important for the power tool as they may involve high power at peak loads. The internal high power hybrid supercapacitors of the energy storage device are configured to provide the peak high current as the discharge ratings of the hybrid supercapacitors is significantly larger than that of Li-ion batteries.

Advantages to the above uses of hybrid supercapacitors include fast charging capability, high discharge currents for applications with high power demand, use at temperatures higher and lower than temperature limits for use of Li-ion batteries, increased lifetime due to no aging battery chemistry, no flammable electrolytes, no expensive PCBAs (e.g., BMS) to control charging and discharging currents, and no known restrictions on shipping.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A power tool comprising:
an electric motor;
an energy storage device (a) that includes hybrid supercapacitors and (b) that has an energy density of at least approximately 150 watt hours per kilogram (Wh/kg), and
at least one switch configured to selectively enable power flow from the energy storage device to the electric motor and to selectively disable power flow from the energy storage device to the electric motor.

2. The power tool of claim 1 wherein the hybrid supercapacitors are electrically connected in series.

3. The power tool of claim 1 wherein the hybrid supercapacitors are electrically connected in parallel.

4. The power tool of claim 1 wherein the hybrid supercapacitors include (a) hybrid supercapacitors that are electrically connected in series and (b) hybrid supercapacitors that are electrically connected in parallel.

5. The power tool of claim 1 further comprising a control module configured to open and close the at least one switch, thereby controlling power flow from the energy storage device to the electric motor.

6. The power tool of claim 5 further comprising an input device, wherein the control module is configured to control switching of the switches based on input from the input device.

7. The power tool of claim 1 wherein the energy storage device is integrated into the power tool and not removable from the power tool.

8. The power tool of claim 1 wherein the energy storage device is removable from the power tool.

9. The power tool of claim 1 wherein the hybrid supercapacitors store power electrostatically.

10. The power tool of claim 1 wherein electrodes of the hybrid supercapacitors include graphene.

11. The power tool of claim 1 wherein electrodes of the hybrid supercapacitors include a nanocarbon material.

12. The power tool of claim 1 wherein the energy storage device has a nominal output voltage of at least 24 volts direct current (DC).

13. The power tool of claim 1 wherein the energy storage device has a power density of at least approximately 1000 W/kg.

14. The power tool of claim 1 wherein the hybrid supercapacitors are each cylindrical.

15. The power tool of claim 14 wherein the hybrid supercapacitors each include two terminals extending outwardly from a circular face of the cylindrical hybrid supercapacitors.

16. The power tool of claim 1 further comprising a circuit board, wherein the hybrid supercapacitors are soldered on the circuit board.

17. A power tool comprising:
an electric motor;
an energy storage device that includes hybrid supercapacitors, wherein each of the hybrid super capacitors includes:
a first electrode that includes a nanocarbon material; and
a second electrode that includes lithium; and
at least one switch configured to selectively enable power flow from the energy storage device to the electric motor and to selectively disable power flow from the energy storage device to the electric motor.

18. The power tool of claim 17 wherein the hybrid supercapacitors are electrically connected in series.

19. The power tool of claim 17 wherein the hybrid supercapacitors are electrically connected in parallel.

20. The power tool of claim 17 wherein the hybrid supercapacitors include (a) hybrid supercapacitors that are electrically connected in series and (b) hybrid supercapacitors that are electrically connected in parallel.

21. The power tool of claim 17 further comprising a control module configured to open and close the at least one switch, thereby controlling power flow from the energy storage device to the electric motor.

22. The power tool of claim 21 further comprising an input device, wherein the control module is configured to control switching of the switches based on input from the input device.

23. The power tool of claim 17 wherein the energy storage device is integrated into the power tool and not removable from the power tool.

24. The power tool of claim 17 wherein the energy storage device is removable from the power tool.

25. The power tool of claim 17 wherein the hybrid supercapacitors store power electrostatically.

26. The power tool of claim 17 wherein nanocarbon material includes graphene.

27. The power tool of claim 17 wherein the energy storage device has a nominal output voltage of at least 24 volts direct current (DC).

28. The power tool of claim 17 wherein the energy storage device has an energy density of at least 150 watt hours (Wh) per kilogram (kg) and a power density of at least approximately 1000 watts per kg.

29. The power tool of claim 17 wherein the hybrid supercapacitors are each cylindrical.

30. The power tool of claim 29 wherein the hybrid supercapacitors each include two terminals extending outwardly from a circular face of the cylindrical hybrid supercapacitors.

31. The power tool of claim 17 further comprising a circuit board, wherein the hybrid supercapacitors are electrically connected via the circuit board and soldering.

32. A charger, comprising:
a plug configured to electrically connect to an alternating current (AC) wall outlet;
a cable electrically connected at one end to the plug;
a converter module configured to receive AC power via the plug and the cable and that is configured to convert the AC power into direct current (DC) power; and
a charging module configured to, using DC power originating from the converter module, charge a first plurality of hybrid supercapacitors that power an electric power tool.

33. The charger of claim 32 further comprising a control module configured to disable the charging module and discontinue the charging when at least one of an over-voltage condition occurs, an over-current condition occurs, and an over-temperature condition occurs.

34. The charger of claim 32 further comprising an energy storage device (a) that is internal to the charger and (b) that includes a second plurality of hybrid supercapacitors.

35. The charger of claim 34 wherein the first plurality of hybrid supercapacitors have a first capacity, the second plurality of hybrid supercapacitors have a second capacity, and the second capacity is greater than the first capacity.

36. The charger of claim 34 wherein the first plurality of hybrid supercapacitors have a first nominal voltage, the second plurality of hybrid supercapacitors have a second nominal voltage, and the second nominal voltage is greater than the first nominal voltage.
